(19) United States
(12) Patent Application Publication
(10) Pub. No.: US 2022/0279825 A1
(43) Pub. Date: Sep. 8, 2022

(54) ENRICHED FLAVOR COMPOSITION

(71) Applicant: FIRMENICH SA, Satigny (CH)

(72) Inventors: Long CHEN, Minhang District, Shanghai (CN); Ke HUANG, Minhang District, Shanghai (CN); Yun YU, Minhang District, Shanghai (CN)

(21) Appl. No.: 17/621,812

(22) PCT Filed: Jun. 26, 2020
(86) PCT No.: PCT/EP2020/068032

§ 371 Date: Dec. 22, 2021

(30) Foreign Application Priority Data
Jun. 28, 2019 (CN) PCT/CN2019/093704
Jul. 18, 2019 (EP) 19187026.0

(51) Int. Cl. A23L 27/10; A23L 27/20; A23L 5/20; A23L 2/56; C12H 3/04; B01D 61/36; B01D 11/04

(52) U.S. Cl. CPC A23L 27/115; A23L 27/2026; A23L 27/2028; A23L 27/204; A23L 5/21; A23L 2/56; C12H 3/04; B01D 61/362; B01D 11/0415

(57) ABSTRACT

Described herein is a method for preparing a dehydrated and de-alcoholized flavor composition by decreasing or removing water and ethanol from a flavor composition, the method including the steps of treating the flavor composition by a dehydration process and dealcoholization process. Also described herein are flavor compositions obtainable by this method, flavored consumer products comprising the same, and methods and uses thereof.

The present invention relates to a method for preparing a dehydrated and de-alcoholized flavor composition by decreasing or removing water and ethanol from a flavor composition, the method comprises the steps of treating the flavor composition by a dehydration process and dealcoholization process, as well as flavor compositions obtainable by this method, flavored consumer products comprising the same and methods and uses thereof.

### BACKGROUND

Water and ethanol can be present in a flavored product or composition either due to the production process for example in the beverage industry during the preparation of for example beer, liquor etc. or in the ethanolic extraction of flavors from natural resources such as plants to obtain or enrich specific flavor compounds. Decreasing or removing water and/or ethanol from a flavored product or composition is desired as the resulting flavored product or composition reduced in ethanol can be desired from a health perspective and/or enriched by the flavoring compounds within the flavor product or composition can be desired from an organoleptic perspective.

WO 2008/099325 describes a process for enriching the aroma profile of beverages such as beer and wine by means of extraction, using pervaporation, of aromas from the original beverage and subsequent addition of the extracted aromas to the beverage after total or partial dealcoholization.

The prior art, however, does not disclose or suggest a process according to the present invention.

One object of the present invention is the provision of a method for decreasing or preferably removing ethanol and water from a flavor composition in order to enrich the flavor composition in its flavor compounds while avoiding the loss of volatile aroma compounds present in the flavor composition.

Another object of the present invention is a flavor composition comprising the ratio of the flavor compounds of the initial flavor composition comprising water and ethanol and/or for flavoring food compositions and products and beverage compositions and products.

### DETAILED DESCRIPTION

The present invention relates to a method for preparing a dehydrated and dealcoholized flavor composition by decreasing or removing water and ethanol from a flavor composition, the method comprises the steps of treating the flavor composition by a dehydration process and dealcoholization process. In other words, the present invention relates to a method for enriching the amount of flavoring ingredients in a flavor composition by decreasing or removing water and ethanol from a flavor composition, the method comprises the steps of treating the flavor composition by a dehydration process and dealcoholization process.

By “flavoring ingredient”, “flavor compound” or similar, it is meant here a compound, which is used in flavoring or perfuming preparations or compositions to impart a hedonic effect. In other words such an ingredient, to be considered as being a flavoring or perfuming one, must be recognized by a person skilled in the art as being able to impart or modify in a positive or pleasant way the taste or the odor of a composition, and not just as having a taste or an odor.

The flavor composition comprises water, ethanol and flavoring ingredient. In a particular embodiment, the flavor composition is in form of a solution or dispersion. Preferably, the flavor composition is in form of a solution.

In a particular embodiment, the flavor composition comprises ethanol in an amount from 5 to 95%, preferably 40 to 90%, more preferably 50 to 80% by weight, based on the total weight of the flavor composition. Thereby, it is understood that the flavor composition comprises ethanol in an amount of at least 5%, 40% and 50% by weight and/or of not more than 95%, 90% and 80% by weight, based on the total weight of the flavor composition.

In a particular embodiment, the flavor composition comprises water in an amount from 5 to 95%, preferably 10 to 40%, more preferably 20 to 30%, by weight, based on the total weight of the composition. Thereby, it is understood that the flavor composition comprises water in an amount of at least 5%, 10% and 20% by weight and/or of not more than 95%, 90% and 80% by weight, based on the total weight of the flavor composition.

In a particular embodiment, the flavor composition comprises ethanol in an amount from 5 to 95%, preferably 40 to 90%, more preferably 50 to 80%, by weight and water in an amount from 5 to 95%, preferably 10 to 40%, more preferably 20 to 30%, by weight, based on the total weight of the composition. Thereby, it is understood that the flavor composition comprises ethanol in an amount of at least 5%, 40% and 50% by weight and/or of not more than 95%, 90% and 80% by weight and water in an amount of at least 5%, 10% and 20% by weight and/or of not more than 95%, 90% and 80% by weight, based on the total weight of the flavor composition.

In a particular embodiment, the flavor composition is a product from a dealcoholization process or fermentation process or in distillery. Thereby, it is understood that the flavor composition can be an ethanolic product, an intermediate product and/or a side-stream product.

The alcoholic product is understood as the desired end product in a dealcolization process, fermentation process or in distillery, preferably in the beverage or food industry, having an increased ethanolic content in comparison to a starting material.

An intermediate product is understood as a product of the dealcoholization process or fermentation process or in distillery, preferably in the beverage or food industry, which cannot be used in the beverage or food industry itself but has to be further processed by additional processes in the beverage or food industry. The intermediate product can comprise an increased or decreased ethanolic content in comparison to the starting material from the dealcoholization process.

The side-stream product from the dealcoholization process is understood as the undesired product in a delocalization process, preferably in the beverage or food industry, having a decreased ethanolic content in comparison to the starting material from the dealcoholization process. In a particular embodiment, the flavor composition is a side-stream product of a dealcoholization process.

In a particular embodiment, the flavor composition is a side-stream product from a dealcoholization process in the beverage or food industry.

In a particular embodiment, the flavor composition is a side-stream product from a dealcoholization process in the beverage industry, such as for example in the dealcoholization process in the production of non-alcohol or alcohol-free beer (i.e. beer with an ethanol content of less than 1.0% by weight, preferably less than 0.5% by weight or more preferably less than 0.1% by weight) or low alcohol beer (i.e. beer with an ethanol content of less than 4% by weight, preferably less than 2% by weight, more preferably less than 1.0% by weight).

In a particular embodiment, the flavor composition is obtained by a reverse osmosis process, spinning cone column process or distillation process, or fermentation process or in distillery.

In a particular embodiment, the flavor composition is obtained by a reverse osmosis process, spinning cone column process or distillation process as the ethanolic product, intermediate product or side-stream product, preferably side-stream product.

In a particular embodiment, the flavor composition is obtained by a reverse osmosis process as the ethanolic product, intermediate product or side-stream product, preferable side-stream product.

Reverse osmosis is understood as a process by which a solvent pass through a porous membrane in the direction opposite to that for natural osmosis when subjected to a hydrostatic pressure greater than the osmotic pressure.

In a particular embodiment, the dehydration process is an adsorption process, pervaporation process or forward osmosis process. Preferably, the dehydration process is a pervaporation process.

Pervaporation or pervaporation process is understood a processing method for the separation of mixtures of liquids by partial vaporization through a non-porous or porous membrane.

In a particular embodiment, the dehydration process, preferably pervaporation process, is conducted using a membrane, preferably hydrophilic membrane.

By hydrophilic membrane is understood a membrane which is able to transfer or transport water through the membrane and at the same time is able to hinder transfer or transport of less hydrophilic compounds and hydrophobic compounds.

In a particular embodiment, the hydrophilic membrane is a porous hydrophilic membrane.

In a particular embodiment, the hydrophilic membrane has a pore diameter in the range of 0.20 to 0.50 nm, preferably in the range of 0.23 and 0.42 nm, more preferably in the range of 0.30 to 0.42 nm.

In a particular embodiment, the dehydration process, preferably a pervaporation process, is conducted using a membrane, preferably hydrophilic membrane, comprising an organic or inorganic material. Non-limiting examples of suitable inorganic materials for the membrane, preferably hydrophilic membrane comprises of zeolites and non-limiting examples of suitable organic materials for the membrane, preferably hydrophilic membrane, comprises polyvinyl alcohol (PVA), chitosan, cellulose or its derivatives, polydimethylsiloxane (PDMS), poly(1-(trimethylsilyI)-1-propyne) (PTMSP), poly(styrenebutadienestyrene) (SBS) or mixtures thereof. The choice of the membrane is function of the composition of the flavor composition, in particular, the amount of water comprised in the flavor composition and the person skilled in the art is well able to select the membrane most suitable in each case to optimize the dehydration process.

In a particular embodiment, the membrane, preferably hydrophilic membrane, comprises an inorganic material.

In a particular embodiment, the hydrophilic membrane comprises a zeolite.

Zeolites are crystalline microporous aluminosilicates with an open framework structure of three-dimensional tetrahedral units generating a network of pores and cavities having molecular dimensions.

In a particular embodiment, zeolites have a pore diameter in the range of 0.20 to 0.50 nm, preferably in the range of 0.23 and 0.42 nm, more preferably in the range of 0.30 to 0.42 nm.

In a particular embodiment, the hydrophilic membrane comprises a NaA zeolite.

NaA zeolites are understood as a synthetic zeolite with very small pores which is normally synthesized in the Na⁺ form, Na₁₂Al₁₂Si₁₂O₄₈≤27H₂O, and has a three-dimensional pore structure.

In a particular embodiment, NaA zeolites have a pore diameter in the range of 0.20 to 0.50 nm, preferably in the range of 0.23 and 0.42 nm, more preferably in the range of 0.30 to 0.42 nm.

In a particular embodiment, the flavor composition is heated before subjecting it to the dehydration process, preferably pervaporation process.

In a particular embodiment, the flavor composition is heated to a temperature of 25 to 100° C., preferably 40 to 100° C., more preferably 60 to 100° C.

In another particular embodiment, the flavor composition is heated to a temperature of 25 to 100° C., preferably 30 to 80° C., more preferably 35 to 70° C.

A skilled person in the art is nevertheless well aware of suitable temperatures to be used in this process step.

In a particular embodiment, the dehydrate fraction comprises less than 50 % by weight, less than 40% by weight, less than 25% by weight, less than 5% by weight, less than 1% by weight of water, based on the total dehydrate fraction.

In a particular embodiment, the dehydrate fraction comprises the flavor compounds and/or ethanol of the flavor composition, i.e. comprises at least 50% by weight of the flavor compounds and/or ethanol, at least 60% by weight of the flavor compounds and/or ethanol, at least 75% by weight of the flavor compounds and/or ethanol and at least 95% by weight of the flavor compounds and/or ethanol, based on the total weight of the total dehydrate fraction.

In a particular embodiment, the hydrate fraction comprises the water of the flavor composition, i.e. comprises at least 50% by weight of the water, at least 60% by weight of the water, at least 75% by weight of the water, at least 95% by weight of the water, based on the total hydrate fraction.

In a particular embodiment, the dehydration process, preferably pervaporation process, results in a dehydrate fraction which comprises low amount of water such as less than 50% by weight, less than 40% by weight, less than 25% by weight, less than 5% by weight, less than 1% by weight of water, based on the total dehydrate fraction and a hydrate fraction which comprises high amounts of water such as more than at least 50% by weight of the water, at least 60% by weight of the water, at least 75% by weight of the water, at least 95% by weight of water, based on the total hydrate fraction.

In a particular embodiment, the dehydrate fraction comprises the flavor compounds and/or ethanol of the flavor composition, i.e. comprises at least 50% of the flavor compounds and/or ethanol, at least 60% of the flavor compounds and/or ethanol, at least 75% of the flavor compounds and/or ethanol and at least 95% of the flavor compounds and/or ethanol, based on the total weight of the total flavor composition.

In a particular embodiment, the dehydrate fraction comprises less than 50% by weight, less than 40% by weight, less than 25% by weight, less than 5% by weight, less than 2% by weight of water, based on the total flavor composition.

In a particular embodiment, the hydrate fraction comprises the water of the flavor composition, i.e. comprises at least 50% of the water, at least 60% of the water, at least 75% of the water, at least 95% by weight of the water, based on the total flavor composition.

In case the dehydration process is conducted by a pervaporation process, the hydrate side of the pervaporation module is under sub-atmospheric pressure.

In a particular embodiment, the hydrate side of the pervaporation module has a sub-atmospheric pressure in the range of 1 mbar to 500 mbar, preferably 1 to 200 mbar. A skilled person is well aware how to choose suitable pressure in this process step.

In a particular embodiment, the dealcoholization process is a distillation process, preferably a vacuum distillation process.

Thereby, it is understood that the ethanol comprised in the dehydrate fraction from the dehydration process is removed so that the flavor compounds remain in the dehydrate fraction thereby forming the de-alcoholized fraction and ethanol is transferred from the dehydrate fraction into the alcoholic fraction.

In a particular embodiment, the dealcoholization process, preferably distillation process, is conducted at a temperature of 25 to 100° C., preferably 30 to 100° C.

In a particular embodiment, the dealcoholization process, preferably distillation process, is conducted at a pressure of 1 mbar to 1 bar, preferably 50 mbar to 500 mbar

Preferably, the dealcoholization process, preferably vacuum-distillation process, is conducted at sub-atmospheric pressure, preferably in the range of 1 to 500 mbar, preferably 50 to 500 mbar.

In a particular embodiment, the de-alcoholized fraction comprises less than 90%, less than 85% by weight, less than 80% by weight, less than 75% by weight, less than 70% by weight, less than 65% by weight, less than 60% by weight, less than 55% by weight, less than 50% by weight, less than 45% by weight, less than 40% by weight, less than 35% by weight, less than 30% by weight, less than 25% by weight, less than 20% by weight, less than 15% by weight, less than 10% by weight, less than 5% by weight of ethanol, based on the total dealcoholized fraction.

In a particular embodiment, the de-alcoholized fraction comprises the flavor compounds of the flavor composition, i.e. comprises at least 5% by weight of the flavor compounds, at least 15% by weight of the flavor compounds, at least 25% by weight of the flavor compounds and at least 35% by weight of the flavor compounds, based on the total weight of the total de-alcoholized fraction.

In a particular embodiment, the alcoholic fraction comprises ethanol from the flavor composition, i.e. comprises at least 50% by weight of the ethanol, at least 60% by weight of the ethanol, at least 75% by weight of the ethanol, at least 95% by weight of the ethanol, based on the total alcoholic fraction.

In a particular embodiment, the dealcoholization process, preferably distillation process, results in a de-alcoholized fraction comprising lower amounts of ethanol such as less than 90%, less than 85% by weight, less than 80% by weight, less than 75% by weight, less than 70% by weight, less than 65% by weight, less than 60% by weight, less than 55% by weight, less than 50% by weight, less than 45% by weight, less than 40% by weight, less than 35% by weight, less than 30% by weight, less than 25% by weight, less than 20% by weight, less than 15% by weight, less than 10% by weight, less than 5% by weight of ethanol, based on the total dealcoholized fraction and an alcoholic fraction comprising high amounts of ethanol such as at least 50% by weight, at least 60% by weight, at least 75% by weight, at least 95% by weight, based on the total alcoholic fraction.

In a particular embodiment, the de-alcoholized fraction comprises the flavor compounds of the flavor composition, i.e. comprises at least 5% of the flavor compounds, at least 15% of the flavor compounds, at least 25% of the flavor compounds and at least 35% of the flavor compounds, based on the total weight of the total flavor composition.

In a particular embodiment, the de-alcoholized fraction comprises less than less than 90%, less than 85% by weight, less than 80% by weight, less than 75% by weight, less than 70% by weight, less than 65% by weight, less than 60% by weight, less than 55% by weight, less than 50% by weight, less than 45% by weight, less than 40% by weight, less than 35% by weight, less than 30% by weight, less than 25% by weight, less than 20% by weight, less than 15% by weight, less than 10% by weight, less than 5% by weight of ethanol, based on the total flavor composition.

In a particular embodiment, the alcoholic fraction comprises ethanol from the flavor composition, i.e. comprises at least 50% of the ethanol, at least 60% of the ethanol, at least 75% of the ethanol, at least 95% of the ethanol, based on the total flavor composition.

In a particular embodiment, the treatment of a flavor composition by a dehydration process and dealcoholization process results in a dehydrated and de-alcoholized flavor composition, wherein dehydrated and de-alcoholized flavor composition compared to flavor composition is enriched in said flavors.

Thereby, it is understood that the dehydrated and de-alcoholized flavor composition compared to the flavor composition comprises the same flavor compounds but which have a higher weight percentage based on the total flavor composition.

In a particular embodiment, the amount of water and ethanol from the flavor composition compared to the dehydrated and de-alcoholized flavor composition is reduced in said flavor composition by the factor of at least 1.5, more preferably at least 20, more preferably at least 40, even more preferably at least 60, most preferably at least 70 reduced.

In other words, the dehydrated and de-alcoholized flavor composition is enriched in said flavor compounds by the factor of at least 1.5, more preferably at least 20, more preferably at least 40, even more preferably at least 60, most preferably at least 70. Thereby, it is understood that at least 3, preferably at least 5, more preferably at least 7, of the flavor compounds have to be enriched by said factor in the dehydrated and de-alcoholized flavor composition compared to the flavor composition, i.e. the reference is the least enriched flavor compound within the dehydrated and de-alcoholized flavor composition.

In a particular embodiment, the dehydrated and dealcoholized flavor composition comprises the flavor compounds in the same ratio of flavor compounds with respect to each other as flavor composition. Thereby, it is understood that the ratio of the main two, preferably three, more preferably four flavor compounds with respect to each other does not change from flavor composition compared to dehydrated and dealcoholized flavor composition.

In a particular embodiment, the flavor compounds are 1-propanol, isobutanol, 2-methyl-1-butanol, 3-methyl-1-butanol, ethyl octanoate, linalool, ethyl decanoate, phenylethyl acetate, octanoic acid, 2-methyoxy-4-vinylphenol, decanoic acid, 3-methylbutyl acetate, ethyl hexanoate, ethyl octanoacte, ethyl decanoate, hexyl acetate, 3-methylbutyl butanoate, 3-methylbutyl hexanoate, 3-methylbutyl octanoate, 3-methylbutyl decanoate, propyl hexanoate, propyl octanoate, propyl decanoate, hexyl hexanoate, hexyl octanoate, isobutyl hexanoate, isobutyl decanoate, diisopentyl carbonate, 1-hexanol, 1-butanol, acetic acid, hexanoic acid, lactic acid, 2-pehenylethanol, diethyl phthalate and/or 3-hydroxy-2-butanone.

In a particular embodiment, the flavor compounds are 1-propanol, isobutanol, 2-methyl-1-butanol, 3-methyl-1-butanol, ethyl octanoate, linalool, ethyl decanoate, phenylethyl acetate, octanoic acid, 2-methyoxy-4-vinylphenol and/or decanoic acid.

In a particular embodiment, the ratio of 1-propanol:2-methyl-1-butanol & 3-methyl-1-butanol is in the range of 1:2.5 to 8, preferably 1:3 to 6.5, more preferably 3.5 to 6.

In a particular embodiment, the ratio of 1-propanol:2-methyl-1-butanol & 3-methyl-1-butanol:isobutanol is in the range of 1:2.5 to 8.0:0.2 to 1.0, preferably 1:3.0 to 6.5:0.35 to 0.9, more preferably 1:3.5 to 6.0:0.4 to 0.75.

In a particular embodiment, the flavor compounds are 3-methylbutyl acetate, ethyl hexanoate, ethyl octanoacte, ethyl decanoate, hexyl acetate, 3-methylbutyl butanoate, 3-methylbutyl hexanoate, 3-methylbutyl octanoate, 3-methylbutyl decanoate, propyl hexanoate, propyl octanoate, propyl decanoate, hexyl hexanoate, hexyl octanoate, isobutyl hexanoate, isobutyl decanoate, diisopentyl carbonate, 3-methyl-1-butanol, 2-methyl-1-butanol, 1-propanol, 1-hexanol, isobutanol, 1-butanol, acetic acid, hexanoic acid, oxctanoic acid, decanoic acid, lactic acid,2-pehenylethanol, phenylethyl acetate, 2-methoxy-4-vinylphenol, diethyl phthalate and/or 3-hydroxy-2-butanone.

In a particular embodiment, the ratio of 1-propanol:2-methyl-1-butanol & 3-methyl-1-butanol is in the range of 1:2.5 to 16, preferably 1:3 to 13, more preferably 3.5 to 10.

In a particular embodiment, the ratio of 1-propanol:2-methyl-1-butanol & 3-methyl-1-butanol:3-methylbutyl acetate is in the range of 1:2.5 to 16:0.2 to 6, preferably 1:3.0 to 13:1 to 5, more preferably 1:3.5 to 10:1.2 to 4.8.

In a particular embodiment, the dehydration process and dealcoholization process are carried out by two subsequent processes.

Thereby, it is understood that as a first step the dehydration process, preferably the pervaporation process, of flavor composition is conducted and as a subsequent second step the dealcoholisation, preferably distillation, of the dehydrate fraction from the dehydration process is conducted without any additional process steps between these two processes.

In a particular embodiment, the dehydration process and dealcoholization process are conducted by two subsequent processes and are comprised in one production line.

Thereby, it is understood that the dehydration process and dealcoholization process are spaced apart from each other but at the same time are in fluid connection with each other.

In a particular embodiment, the dehydration process and dealcoholization process is conducted by two subsequent processes and are comprised in one production line in fluid connection with a previous dealcoholization process from the beverage industry.

In an alternative embodiment, the dehydration process and dealcoholization process is conducted in one single process.

Thereby, it is understood that the dehydration process and dealcoholization process of flavor composition is conducted in one single process. This can for example be conducted by selecting a specific hydrophilic membrane which can reduce or remove both water and ethanol from flavor composition.

In a particular embodiment, the dehydration process and the dealcoholization process are conducted in one single process and is comprised in one production line in fluid connection with a previous dealcoholization process from the beverage industry.

The present invention also relates to a flavor composition obtainable by the method as defined hereinabove.

In a particular embodiment, the flavor composition obtainable by the method according to the invention comprises a low amount of water such as less than as less than 50% by weight, less than 40% by weight, less than 25% by weight, less than 5% by weight, less than 1% by weight of water, based on the total flavor composition.

In a particular embodiment, the flavor composition obtainable by the method according to the invention comprises a low amount of ethanol such as less than 90% by weight, less than 85% by weight, less than 80% by weight, less than 75% by weight, less than 70% by weight, less than 65% by weight, less than 60% by weight, less than 55% by weight, less than 50% by weight, less than 45% by weight, less than 40% by weight, less than 35% by weight, less than 30% by weight, less than 25% by weight, less than 20% by weight, less than 15% by weight, less than 10% by weight, less than 5% by weight of ethanol, based on the total flavor composition.

In a particular embodiment, the flavor composition obtainable by the method according to the invention comprises a high amount of flavor compounds such as at least 5% by weight of the flavor compounds, at least 15% by weight of the flavor compounds, at least 25% by weight of the flavor compounds and at least 35% by weight of the flavor compounds, based on the total flavor composition.

In a particular embodiment, the flavor composition obtainable by the present invention comprises at least one of the flavor compounds selected from the group consistin of 1-propanol, isobutanol, 2-methyl-1-butanol, 3-methyl-1-butanol, ethyl octanoate, linalool, ethyl decanoate, phenylethyl acetate, octanoic acid, 2-methyoxy-4-vinylphenol, decanoic acid, 3-methylbutyl acetate, ethyl hexanoate, ethyl octanoacte, ethyl decanoate, hexyl acetate, 3-methylbutyl butanoate, 3-methylbutyl hexanoate, 3-methylbutyl octanoate, 3-methylbutyl decanoate, propyl hexanoate, propyl octanoate, propyl decanoate, hexyl hexanoate, hexyl octanoate, isobutyl hexanoate, isobutyl decanoate, diisopentyl carbonate, 1-hexanol, 1-butanol, acetic acid, hexanoic acid, lactic acid, 2-pehenylethanol, diethyl phthalate and/or 3-hydroxy-2-butanone

In a particular embodiment, the flavor composition obtainable by the present invention comprises at least one of the flavor compounds selected from the group consisting of 1-propanol, isobutanol, 2-methyl-1-butanol, 3-methyl-1-butanol, ethyl octanoate, linalool, ethyl decanoate, phenylethyl acetate, octanoic acid, 2-methyoxy-4-vinylphenol and/or decanoic acid.

Preferably, the flavor composition obtainable by the present invention comprises at least two, at least three, at least four, at least 5, at least 7 and at least 9 of the aforementioned flavor compounds. In a particular preferred embodiment, the flavor composition obtainable by the present invention comprises all of the aforementioned flavor compounds.

In a particular embodiment, the flavor composition obtainable by the present invention comprises at least 2.5% by weight, preferably at least 3% by weight and more preferably 4 by weight of 1-propanol, based on the total flavor composition.

In a particular embodiment, the flavor composition obtainable by the present invention comprises at least 1% by weight, preferably at least 1.5% by weight and more preferably at least 2% by weight of isobutanol, based on the total flavor composition.

In a particular embodiment, the flavor composition obtainable by the present invention comprises at least 10% by weight, preferably at least 12.5% by weight and more preferably at least 15% by weight of 2-methyl-1-butanol and 3-methyl-1-butanol, based on the total flavor composition.

In a particular embodiment, the flavor composition obtainable by the present invention comprises at least 0.001% by weight, preferably at least 0.01% by weight and more preferably at least 0.02% by weight of ethyl octanoate, based on the total flavor composition.

In a particular embodiment, the flavor composition obtainable by the present invention comprises at least 0.001% by weight, preferably at least 0.01% by weight and more preferably at least 0.02% by weight of linalool, based on the total flavor composition.

In a particular embodiment, the flavor composition obtainable by the present invention comprises at least 0.001% by weight, preferably at least 0.01% by weight and more preferably at least 0.02% by weight of ethyl decanoate, based on the total flavor composition.

In a particular embodiment, the flavor composition obtainable by the present invention comprises at least 0.001% by weight, preferably at least 0.01% by weight and more preferably at least 0.02% by weight of phenylethyl acetate, based on the total flavor composition.

In a particular embodiment, the flavor composition obtainable by the present invention comprises at least 0.001% by weight, preferably at least 0.01% by weight and more preferably at least 0.02% by weight of octanoic acid, based on the total flavor composition.

In a particular embodiment, the flavor composition obtainable by the present invention comprises at least 0.001% by weight, preferably at least 0.01% by weight and more preferably at least 0.02% by weight of 2-methoxy-4-vinylphenol, based on the total flavor composition.

In a particular embodiment, the flavor composition obtainable by the present invention comprises at least 0.001% by weight, preferably at least 0.01% by weight and more preferably at least 0.02% by weight of decanoic acid, based on the total flavor composition.

In a particular embodiment, the ratio of the flavor compounds 1-propanol:2-methyl-1-butanol and 3-methyl-1-butanol is in the range of 1:2.5 to 8, preferably 1:3 to 6.5, more preferably 3.5 to 6.

In a particular embodiment, the ratio of the flavor compounds 1-propanol:2-methyl-1-butanol & 3-methyl-1-butanol:isobutanol is in the range of 1:2.5 to 8.0:0.2 to 1.0, preferably 1:3.0 to 6.5:0.35 to 0.9, more preferably 1:3.5 to 6.0:0.4 to 0.75.

In a particular embodiment, the flavor composition obtainable by the present invention comprises at least one of the flavor compounds selected from the group consisting of 3-methylbutyl acetate, ethyl hexanoate, ethyl octanoacte, ethyl decanoate, hexyl acetate, 3-methylbutyl butanoate, 3-methylbutyl hexanoate, 3-methylbutyl octanoate, 3-methylbutyl decanoate, propyl hexanoate, propyl octanoate, propyl decanoate, hexyl hexanoate, hexyl octanoate, isobutyl hexanoate, isobutyl decanoate, diisopentyl carbonate, 3-methyl-1-butanol, 2-methyl-1-butanol, 1-propanol, 1-hexanol, isobutanol, 1-butanol, acetic acid, hexanoic acid, oxctanoic acid, decanoic acid, lactic acid, 2-pehenylethanol, phenylethyl acetate, 2-methoxy-4-vinylphenol, diethyl phthalate and/or 3-hydroxy-2-butanone.

In a particular embodiment, the ratio of 1-propanol:2-methyl-1-butanol & 3-methyl-1-butanol is in the range of 1:2.5 to 16, preferably 1:3 to 13, more preferably 3.5 to 10.

In a particular embodiment, the ratio of 1-propanol:2-methyl-1-butanol & 3-methyl-1-butanol:3-methylbutyl acetate is in the range of 1:2.5 to 16:0.2 to 6, preferably 1:3.0 to 13:1 to 5, more preferably 1:3.5 to 10:1.2 to 4.8.

According to any embodiment of the invention, at least one flavor carrier may be added to the flavor composition obtainable by the present invention. The term “flavor carrier” designate a material which is substantially neutral from a flavor point of view, insofar as it does not significantly alter the organoleptic properties of flavoring ingredients ingredients. The carrier may be a liquid or a solid.

Suitable liquid carriers include, for instance, an emulsifying system, i.e. a solvent and a surfactant system, or a solvent commonly used in flavors or perfumery. A detailed description of the nature and type of solvents commonly used in flavor or perfumery cannot be exhaustive. Suitable solvents used in flavor include, for instance, propylene glycol, triacetine, caprylic/capric triglyceride (neobee®), triethyl citrate, benzylic alcohol, ethanol, vegetable oils such as Linseed oil, sunflower oil or coconut oil or terpenes. One can cite as non-limiting examples of perfumery solvents, solvents such as butylene or propylene glycol, glycerol, dipropyleneglycol and its monoether, 1,2,3-propanetriyl triacetate, dimethyl glutarate, dimethyl adipate 1,3-diacetyloxypropan-2-yl acetate, diethyl phthalate, isopropyl myristate, benzyl benzoate, benzyl alcohol, 2-(2-ethoxyethoxy)-1-ethano, tri-ethyl citrate, ethanol, water/ethanol mixtures, limonene or other terpenes, isoparaffins such as those known under the trademark Isopar® (origin: Exxon Chemical) or glycol ethers and glycol ether esters such as those known under the trademark Dowanol® (origin: Dow Chemical Company), or hydrogenated castors oils such as those known under the trademark Cremophor® RH 40 (origin: BASF) or mixtures thereof.

Suitable solid carriers include, for instance, absorbing gums or polymers, or even encapsulating materials. Examples of such materials may comprise wall-forming and plasticizing materials, such as mono, di- or polysaccharides, natural or modified starches, hydrocolloids, cellulose derivatives, polyvinyl acetates, polyvinylalcohols, proteins or pectins, or yet the materials cited in reference texts such as H. Scherz, Hydrokolloid:Stabilisatoren, Dickungs- and Geliermittel in Lebensmitteln, Band 2 der Schriftenreihe Lebensmittelchemie, Lebensmittelqualität, Behr's VerlagGmbH & Co., Hamburg, 1996. Encapsulation is a well-known process to a person skilled in the art, and may be performed, for instance, using techniques such as spray-drying, agglomeration, extrusion, coating, plating, coacervation and the like.

According to any embodiment of the invention, at least one flavor adjuvant may be added to the flavor composition obtainable by the present invention. By “flavor adjuvant”, it is meant here an ingredient capable of imparting additional added benefit such as a color (e.g. caramel), chemical stability, and so on. A detailed description of the nature and type of adjuvant commonly used in flavoring compositions cannot be exhaustive. Nevertheless, such adjuvants are well known to a person skilled in the art who will be able to select them on the basis of its general knowledge and according to intended use or application. One may cite as specific non-limiting examples the following: viscosity agents (e.g. emulsifier, thickeners, gelling and/or rheology modifiers), stabilizing agents (e.g. antioxidant, heat/light and or buffers agents), coloring agents (e.g. natural or synthetic or natural extract imparting color), preservatives (e.g. antibacterial or antimicrobial or antifungal agents), vitamins and mixtures thereof.

Furthermore, the flavor composition obtainable by the present invention can be advantageously used in all the fields of flavor to positively impart or modify the taste of a consumer product into which said composition is added. Consequently, the present invention relates to a flavored consumer product comprising the flavor composition obtainable by the present invention.

For the sake of clarity, by “flavored consumer product” it is meant to designate an edible product or oral composition such as, for example, pharmaceutical compositions, edible gel mixes and compositions, dental compositions, foodstuffs beverages and beverage products. The flavored consumer product may be in a different form. A non-exhaustive list of suitable form of the consumer product may include fried, frozen marinated, battered, chilled, dehydrated, powder blended, canned reconstituted, retorted, baked, cooked, fermented, microfiltred, pasteurized, blended or preserved. Therefore, a flavored consumer product according to the invention comprises the flavor composition obtainable by the present invention, as well as optional benefit agents, corresponding to taste and flavor profile of the desired edible product, e.g. a alcohol-free-beer.

The nature and type of the constituents of the foodstuffs or beverages do not warrant a more detailed description here, the skilled person being able to select them on the basis of his general knowledge and according to the nature of said product.

Typical examples of said flavored consumer product include:
Baked goods (e.g. breads, dry biscuits, cakes, rice cakes, rice crackers, cookies, crackers, donuts, muffins, pastries, pre-mixes, other baked goods),
Non-alcoholic beverages (e.g. alcohol-free-beer, aqueous beverages, enhanced/slightly sweetened water drinks, flavored carbonated and still mineral and table waters, carbonated soft drinks, non-carbonated beverages, carbonated waters, still waters, softs, bottled waters, sports/energy drinks, juice drinks, vegetable juices, vegetable juice preparations, broth drinks),
Alcoholic beverages (e.g. beer and malt beverages, low alcohol beer, spirituous beverages, wines, liquors),
Instant or ready-to-drink beverages (e.g. instant vegetable drinks, powdered soft drinks, instant coffees and teas, black teas, green teas, oolong teas, herbal infusions, cacaos (e.g. water- based), tea-based drinks, coffee-based drinks, cacao-based drinks, infusions, syrups, frozen fruits, frozen fruit juices, water-based ices, fruit ices, sorbets),
Cereal products (e.g. breakfast cereals, cereal bars, energy bars/nutritional bars, granolas, pre-cooked ready-made rice products, rice flour products, millet and sorghum products, raw or pre-cooked noodles and pasta products),
Dairy based products (e.g. fruit or flavored yoghurts, ice creams, fruit ices, frozen desserts, fresh cheeses, soft cheeses, hard cheeses, milk drinks, wheys, butters, partially or wholly hydrolysed milk protein-containing products, fermented milk products, condensed milks and analogues)
Dairy analogues (imitation dairy products) containing non-dairy ingredients (plant-based proteins, vegetable fats),
Confectionary products (e.g. filings, toppings, chewing gums, hard and soft candies),
Chocolate and compound coatings (e.g. chocolates, spreads),
Products based on fat and oil or emulsions thereof (e.g. mayonnaises, spreads, regular or low fat margarines, butter/margarine blends, flavored oils, shortenings, remoulades, dressings, salad dressings, spice preparations, peanut butters),
Eggs or egg products (dried eggs, egg whites, egg yolks, custards),
Desserts (e.g. gelatins, puddings, dessert creams),
Products made of soya protein or other soya bean fractions (e.g. soya milk and products made therefrom, soya lecithin-containing preparations, fermented products such as tofu or tempeh or products manufactured therefrom, soya sauces),
Vegetable preparations (e.g. ketchups, sauces, processed and reconstituted vegetables, dried vegetables, deep frozen vegetables, pre-cooked vegetables, vegetables pickled in vinegar, vegetable concentrates or pastes, cooked vegetables, potato preparations),
Fruit preparations (e.g. jams, marmalades, canned fruits)
Vegetarian meat analogues or meat replacers, vegetarian burgers
Spices or spice preparations (e.g. mustard preparations, horseradish preparations, pickles), spice mixtures and, in particular seasonings which are used, for example, in the field of snacks.
Snack articles (e.g. baked or fried potato crisps or potato dough products, bread dough products, extrudates based on maize, rice or ground nuts),
Ready dishes (e.g. instant noodles, rice, pastas, pizzas, tortillas, wraps) and soups and broths (e.g. stock, savory cubes, dried soups, instant soups, pre-cooked soups, retorted soups), sauces (instant sauces, dried sauces, ready-made sauces, gravies, sweet sauces, a relish sauces, a sour sauces),
oral care product, such as toothpastes, mouth washes, dental care products (e.g. denture adhesives), dental rinsing, mouth sprays, dental powders, dental gels or dental floss,
pet or animal food.

Preferably, the flavored consumer product may be non-alcoholic beverages, alcoholic beverages or instant or ready-to-drink beverages.

Preferably, the flavored consumer product may be drinks aqueous beverages, enhanced/slightly sweetened water drinks, flavored carbonated and still mineral and table waters, carbonated soft drinks, non-carbonated beverages, carbonated waters, still waters, softs, bottled waters, sports/energy drinks, juice drinks, vegetable juices, vegetable juice preparations, free-alcohol-beer, low alcohol beer, beer and malt beverages, spirituous beverages, wines, liquors, instant vegetable drinks, powdered soft drinks, instant coffees and teas, black teas, green teas, oolong teas, herbal infusions, cacaos, tea-based drinks, coffee-based drinks, cacao-based drinks, infusions and syrups.

Some of the above-mentioned flavored consumer products may represent an aggressive medium for the flavor composition obtainable by the present invention, so that it may be necessary to protect the latter from premature decomposition, for example by encapsulation.

The proportions in which the flavor composition obtainable by the present invention can be incorporated into the various of the aforementioned products vary within a wide range of values. These values are dependent on the nature of the consumer product to be flavored and on the desired organoleptic effect as well as the nature of the co-ingredients in a given base when the composition according to the invention are mixed with flavoring ingredients, solvents or additives commonly used in the art.

For example, in the case of flavored consumer product, typical concentrations are in the order of 0.001 ppm to 10000 ppm, more preferably 0.1 ppm to 8000 ppm, even more preferably 10 ppm to 5000 ppm, of the invention's composition based on the weight of the consumer product into which they are incorporated.

The present invention also relates to a method of preparing a flavored food or beverage article, the method comprising the steps of:
a) providing a food carrier or base or beverage carrier or base, respectively,
b) adding to the food carrier or base or beverage carrier or base, respectively, the flavor composition obtainable by the method as defined hereinabove.

Thereby, it is understood that the flavor composition obtainable by the method according to the invention is capable to increase, enhance, confer or modify the organoleptic profile of a food carrier or base or beverage carrier or base when added thereto.

In a particular embodiment, the food carrier or base can be fried or not, as well as frozen or not, low fat or not, marinated, battered, chilled, dehydrated, instant, canned, reconstituted, retorted or preserved.

In a particular embodiment, the food carrier or base comprise a seasonings or condiment, such as a stock, a savory cube, a powder mix, a flavored oil, a sauce (e.g. a relish, barbecue sauce, a dressing, a gravy or a sweet and/or sour sauce), a salad dressing or a mayonnaise; a meat-based product, such as a poultry, beef or pork based product, a seafood, surimi, or a fish sausage; a soup, such as a clear soup, a cream soup, a chicken or beef soup or a tomato or asparagus soup; a carbohydrate-based product, such as instant noodles, rice, pasta, potatoes flakes or fried, noodles, pizza, tortillas, wraps; a dairy or fat product, such as a spread, a cheese, or regular or low fat margarine, a butter/margarine blend, a butter, a peanut butter, a shortening, a processed or flavored cheese; a savory product, such as a snack, a biscuit (e.g. chips or crisps) or an egg product, a potato/tortilla chip, a microwave popcorn, nuts, a bretzel, a rice cake, a rice cracker, etc; an imitation products, such as a dairy (e. g. a reformed cheese made from oils, fats and thickeners) or seafood or meat (e.g. a vegetarian meat replacer, veggie burgers) analogue; or a pet or animal food.

In a particular embodiment, the beverage carrier or base a soft drink, such as a carbonated soft drink, including cola, lemon-lime, root beer, heavy citrus (“due type”), fruit flavored and cream sodas, and diet drink; powdered soft drinks, as well as liquid concentrates such as fountain syrups and cordials; coffee and coffee based drinks, coffee substitutes and cereal-based beverages; teas, including dry mix products as well as ready to drink teas (herbal and tealeaf based); fruit and vegetable juices and juice flavored beverages as well as juice drinks, nectars, concentrates and punches; sweetened and flavored waters, both carbonated and still; sport/energy/health drinks; alcoholic beverages plus alcohol-free and other low-alcohol products including beer and malt beverages, cider and wines (still, sparkling, fortified wines and wine coolers); other beverages processed with heating (infusions; pasteurization, ultrahigh temperature, ohmic heating or commercial aseptic sterilization) and hot-filled packaging; and cold-filled products made through filtration or other preservation techniques.

In a particular embodiment, the method is preferably directed to preparing a flavored beverage article.

The present invention also relates to a use of a flavor composition obtainable by the method as defined hereinabove for preparing a flavored food or beverage article.

The particular embodiments with regard to the method of preparing a flavored food or beverage article apply mutatis mutandis to the use of a flavor composition.

### EXAMPLES

1. Pervaporation Process

The pervaporation membrane is made of NaA zeolite which is a class of highly ordered, porous and crystalline silica containing materials, exhibiting uniform and very small pore diameters.

The pervaporation experiments were performed with a tubular laboratory stainless steel permeation cell with an effective membrane area of 300 cm² in contact with the feed mixture. The feed liquid mixture was firstly heated in a heater before pumped into the membrane module. A vacuum pump kept the permeate side of the membrane module under sub-atmospheric pressure, which provides the driving force to transfer water from the feed side to the permeate side. The permeate was condensed in two parallel glass cold traps cooled by liquid nitrogen to ensure that all permeates could be fully collected.

2. Distillation Process

A standard laboratory unit was used for the distillation experiments. A 1 L 3-neck round-bottom flask agitated with a magnetic stirrer was used as distillation pot. The column had a diameter of 25 mm and contained 33 cm of packing. All the process parameters were manually controlled.

3. Results and Discussion

### 3.1. Compositions of the Starting Flavor Composition

The starting material, the side stream from a dealcoholization process in the beverage industry (beer) using reverse osmosis was analyzed by GC-MS.

The major flavor compounds present in the side stream obtained from the dealcoholization process are listed in Table 1.

TABLE 1
Composition analysis result of starting material

| | Conc. | | Conc. | | Conc. |
|---|---|---|---|---|---|
| Alcohols | (mg/L) | Esters | (mg/L) | Acids | (mg/L) |
| 1-Propanol | 62.5 | 3-Methylbutyl | 5.9 | octanoic | 24.1 |
| | | acetate | | acid | |
| Isobutanol | 29.6 | Ethyl | 1.1 | decanoic | 19.4 |
| | | hexanoate | | acid | |
| Butanol | 0.9 | Ethyl octanoate | 3.4 | | |
| 2-Methyl-1- | 93.1 | 3-(Methylthio) | 0.2 | | |
| butanol | | propyl acetate | | | |
| 3-Methyl-1- | 338.7 | Ethyl | 3.2 | | |
| butanol | | decanoate | | | |
| Phenethylol | 2.6 | Phenylethyl | 12 | | |
| | | acetate | | | |
| 2-Methoxy-4- | 3.6 | Ethyl | 0.6 | | |
| vinylphenol | | dodecanoate | | | |

In the starting material, the water and ethanol amount were approximately 74% and 25%, respectively, and the total aroma compounds was about 600 ppm.

### 3.2. Aroma Concentration via Direct Distillation

For concentrating the aromas or flavor compounds by removing ethanol and water, the side stream was subjected to distillation directly. During the distillation process, the vacuum and reflux ratio were tuned. Initially, the vacuum was set as 125 mbar with reflux ratio as 1, and the pot temperature was set as 37° C. In this stage, the result clearly indicated that 1-proponal and isobutanol were stripped out with ethanol and water. With the decreasing of vacuum and increasing of the pot temperature in the latter distillation stage, more and more aroma or flavor compounds were distilled out. These results demonstrated that the aroma concentrating via direct distillation does not work for this case.

### 3.3. Water Removal via Pervaporation

In order to remove water from the side stream, pervaporation experiments were conducted using the process as reported in example 1. The result of dehydration is shown in Table 2. The concentration of water in the feed decreased over the experimental time, as the experiments were carried out in batch mode. After half of an hour, the water content was reduced to 0.2%.

This result demonstrates that the pervaporation process can efficiently remove water from the side stream.

TABLE 2
Pervaporation experiment conditions and results

| | Evaporator | Water content | Water content | |
|---|---|---|---|---|
| Time | pressure | of RM | of permeate | Flux |
| (min) | (MPa) | (wt. %) | (wt. %) | (kg · m⁻² · h⁻¹) |
| 10 | 0.29 | 15.24 | 98.28 | 6.44 |
| 13 | 0.30 | 16.35 | 100 | 6.76 |
| 14 | 0.31 | 14.17 | 100 | 6.22 |
| 13 | 0.31 | 10.49 | 98.81 | 5.99 |
| 11 | 0.31 | 8.59 | 97.73 | 5.44 |
| 10 | 0.31 | 6.46 | 95.47 | 4.87 |
| 15 | 0.33 | 4.16 | 96.82 | 3.31 |
| 20 | 0.32 | 1.83 | 98.81 | 1.85 |
| 27 | 0.32 | 0.68 | 93.46 | 0.74 |
| 30 | 0.31 | 0.2 | 89.85 | 0.23 |

Experiment conditions: 1668 gram of raw material, 100° C., 30 min

### 3.4 Further Concentration via Distillation

After dehydration, the post-mixture was concentrated via distillation. The distillation conditions are listed in Table 3 using the set-up reported in example 2. Total 857 grams of the dehydration materials were subjected to distillation. After the distillation, 832 grams of distillates and 7.8 grams of residue were collected.

TABLE 3
Experiment parameters of the distillation experiments

| Experiment Parameters | Value | |
|---|---|---|
| Head pressure | 90 | mbar |
| T_{oil bath} | 50° | C. |
| T_{head} | 27° | C. |
| Tₚₒₜ | 28.4° | C. |

| | |
|---|---|
| Reflux ratio | 1 |
| Column | EX packing ϕ 2.5 × 33 cm |

In the distillate part, there were only ethanol and trace of water, and the aroma compounds were not detected by GC. After pervaporation and distillation, most of the key aroma compounds in the starting side stream were folded over 80 times, as shown in Table 4. This result indicates that the dehydration treatment was necessary and beneficial for further concentration.

TABLE 4
The comparison of the aromas composition
in RM and final product

| | Conc. in | Conc. in | |
|---|---|---|---|
| | raw material | product | Folding |
| Molecules | (GC peak area %) | (GC peak area %) | factor |
| 1-Propanol | 0.054 | 5.552 | 102 |
| Isobutanol | 0.035 | 3.137 | 89 |
| 2-Methyl-1-butanol & | 0.299 | 25.577 | 85 |
| 3-Methyl-1-butanol | | | |
| Ethyl octanoate | 0.001 | 0.091 | 91 |
| Linalool | 0.003 | 0.269 | 89 |
| Ethyl decanoate | 0.001 | 0.083 | 83 |
| Phenylethyl acetate | 0.004 | 0.299 | 74 |
| octanoic acid | 0.010 | 0.893 | 89 |
| 2-methoxy-4- | 0.001 | 0.087 | 87 |
| vinylphenol | | | |
| decanoic acid | 0.008 | 0.691 | 86 |

4. Further Example for Obtaining the Flavor Composition

The starting material is from wine. The dehydration and de-alcoholization process has been carried out as described in Examples 1 to 3.

TABLE 5
The comparison of the aroma composition in
the starting material and final product

| | | Starting | | |
|---|---|---|---|---|
| | Main aroma | material | Concentrates | Folding |
| Category | components | mg/L | mg/L | factor |
| Ester | 3-methylbutyl acetate | 132 | 23130.5 | 175.2 |
| | Ethyl hexanoate | 16.3 | 7102.8 | 435.8 |
| | Ethyl octanoate | 25.5 | 6512.0 | 255.4 |
| | Ethyl decanoate | 9 | 1858.5 | 206.5 |
| | Hexyl acetate | 3.1 | 714.8 | 230.6 |
| | 3-methylbutyl | — | 216.6 | |
| | butanoate | | | |
| | 3-methylbutyl | — | 2294.5 | |
| | hexanoate | | | |
| | 3-methylbutyl | — | 2403.0 | |
| | octanoate | | | |
| | 3-methylbutyl | — | 813.1 | |
| | decanoate | | | |
| | Propyl hexanoate | — | 131.7 | |
| | Propyl octanoate | — | 138.7 | |
| | Propyl decanoate | — | 49.4 | |
| | Hexyl hexanoate | — | 64.5 | |
| | Hexyl octanoate | — | 49.7 | |
| | Isobutyl hexanoate | — | 75.0 | |
| | Isobutyl decanoate | — | 57.8 | |
| | Diisopentyl carbonate | — | 62.9 | |
| Alcohol | 3-methyl-1-butanol | 1803.5 | 82822.2* | 40.8 |
| | 2-methyl-1-butanol | 228 | | |
| | 1-propanol | 336.8 | 9433.7 | 28.0 |
| | 1-hexanol | 30.1 | 2135.1 | 70.9 |
| | Isobutanol | — | 7937.2 | |
| | 1-butanol | — | 230.9 | |
| Acid | acetic acid | 311.5 | 1279.1 | 4.1 |
| | hexanoic acid | 56 | 463.2 | 8.3 |
| | octanoic acid | 190.6 | 354.8 | 1.9 |
| Phenyl | 2-phenylethanol | 38.7 | 287.9 | 7.4 |

### 5. Temperature Effect

In order to understand the temperature effect on the membrane performance, two experiments were conducted under 80° C. and 100° C., respectively. The material used was whiskey.

The experiment result is indicated in the following Tables 6 and 7. It indicates that higher operation temperature can enhance the flux, more specifically, the flux was almost doubled in the first phase. In the meantime, it was found that the flux dropped sharply when the water content in the raw material was reduced to a certain level.

TABLE 6
Whisky Pervaporation ( 1 membrane, 80° C. )

| Total | | | | | Total | Permeation | |
|---|---|---|---|---|---|---|---|
| time | T_{in-membrane} | Ms | Mf | Permeate | permeate | flux | Total flux |
| (min) | (° C.) | (g) | (g) | (g) | (g) | ( kg/(m² · h)) | ( kg/(m² · h)) |
| 30.05 | 80.3 | 219.81 | 286.3 | 66.49 | 66.49 | 4.425 | 4.43 |
| 60.05 | 80.7 | 219.76 | 284.07 | 64.31 | 130.8 | 4.287 | 4.36 |
| 90.07 | 80.6 | 208.73 | 272.43 | 63.7 | 194.5 | 4.244 | 4.32 |
| 120.09 | 80.3 | 213.05 | 273.06 | 60.01 | 254.51 | 3.998 | 4.24 |
| 150.12 | 80.3 | 213.14 | 271.28 | 58.14 | 312.65 | 3.872 | 4.17 |
| 180.17 | 80.3 | 218.49 | 271.25 | 52.76 | 365.41 | 3.511 | 4.06 |
| 215.17 | 80.1 | 217.18 | 272.17 | 54.99 | 420.4 | 3.142 | 3.91 |
| 250.19 | 79.8 | 217.81 | 260.74 | 42.93 | 463.33 | 2.452 | 3.70 |
| 295.24 | 79.6 | 223.01 | 254.03 | 31.02 | 494.35 | 1.377 | 3.35 |
| 355.24 | 80.4 | 220.51 | 230.47 | 9.96 | 504.31 | 0.332 | 2.84 |
| 385.24 | 80.2 | 215.39 | 217.61 | 2.22 | 506.53 | 0.148 | 2.63 |
| / | / | 218.71 | 219.26 | 0.55 | 507.08 | / | / |

| Mass of feed | Water content |
|---|---|
| (g) | (%) |
| 1000.83 | 54.71 |

TABLE 7
Whiskey Pervaporation (1 membrane, 100° C.)

| | Total | | | | | Total | Permeation | |
|---|---|---|---|---|---|---|---|---|
| Time | time | T_{in-membrane} | | | Permeate | permeate | flux | Total flux |
| (min) | (min) | (° C.) | Ms (g) | Mf (g) | (g) | (g) | ( kg/(m² · h)) | ( kg/(m² · h)) |
| 15.03 | 15.03 | 100.7 | 219.49 | 283.15 | 63.66 | 63.66 | 8.471 | 8.47 |
| 13.93 | 28.96 | 100.3 | 216.21 | 275.83 | 59.62 | 123.28 | 8.560 | 8.51 |
| 15 | 43.96 | 99.9 | 218.44 | 280.75 | 62.31 | 185.59 | 8.308 | 8.44 |
| 15.03 | 58.99 | 100 | 214 | 273.62 | 59.62 | 245.21 | 7.933 | 8.31 |
| 15 | 73.99 | 100.5 | 221.26 | 278.95 | 57.69 | 302.9 | 7.692 | 8.19 |
| 18 | 91.99 | 101.4 | 217.29 | 281.42 | 64.13 | 367.03 | 7.126 | 7.98 |
| 18.02 | 110.01 | 100.2 | 216.79 | 271.69 | 54.9 | 421.93 | 6.093 | 7.67 |
| 18.03 | 128.04 | 100 | 212.23 | 251.16 | 38.93 | 460.86 | 4.318 | 7.20 |
| 30.23 | 158.27 | 100.4 | 217.02 | 241.2 | 24.18 | 485.04 | 1.600 | 6.13 |
| 60.27 | 218.54 | 100~101 | 214.61 | 225.72 | 11.11 | 496.15 | 0.369 | 4.54 |
| 41 | 259.54 | 100~101 | 221.9 | 224.96 | 3.06 | 499.21 | 0.149 | 3.85 |

| Mass of feed | Water content | Mass of product |
|---|---|---|
| (g) | (%) | (g) |
| 999.39 | 54.71 | 491.81 |

1. A method for preparing a dehydrated and de-alcoholized flavor composition by decreasing or removing water and ethanol from a flavor composition, the method comprising the steps of treating the flavor composition by a dehydration process and dealcoholization process.

2. The method according to claim 1, wherein the flavor composition is in a form of a solution or dispersion.

3. The method according to claim 1, wherein the flavor composition comprises ethanol in the amount from 5 to 95%, by weight and water in an amount from 5 to 95% based on the total weight of the flavor composition.

4. The method according to claim 1, wherein the flavor composition is a product of a dealcoholization process.

5. The method according to claim 1, wherein the flavor composition is obtained by a reverse osmosis process

6. The method according to claim 1, wherein the dehydration process is an adsorption process or pervaporation process.

7. The method according to claim 1, wherein the dehydration process is conducted using a hydrophilic membrane.

8. The method according to claim 1, wherein the dealcoholization process is a distillation process.

9. The method according to claim 1, wherein the amount of water and ethanol from the flavor composition is reduced in said flavor composition by a factor of at least 2.

10. A flavor composition obtainable by the method as defined in claim 1.

11. A flavored consumer product comprising the composition as defined in claim 10.

12. The flavored consumer product according to claim 11, wherein the flavored consumer product is selected from the group consisting of baked goods, dairy based products, dairy analogues, products based on fat and oil or emulsions thereof, milk products, desserts, chocolate and compound coatings, cereal products, confectionary and products based on sugar non-alcoholic beverages, alcoholic beverages and instant beverages.

13. The flavored consumer product according to claim 11, wherein the flavored consumer product is selected from the group consisting of breads, dry biscuits, cakes, rice cakes, rice crackers, cookies, crackers, donuts, muffins, pastries, fruit or flavored yoghurts, ice creams, fruit ices, frozen desserts, spreads, regular or low fat margarines, butter/margarine blends, flavored oils, shortenings, dressings, spice preparations, peanut butters, fresh cheeses, soft cheeses, milk drinks, wheys, butters, partially or wholly hydrolysed milk protein-containing products, fermented milk products, condensed milk and analogues, gelatins, puddings, dessert creams, chocolates, spreads, confectionaries, filing and couverture products, sugar base products, aqueous beverages, enhanced/slightly sweetened water drinks, flavored carbonated and still mineral and table waters, carbonated soft drinks, non-carbonated beverages, carbonated waters, still waters, softs, bottled waters, sports/energy drinks juice drinks, vegetable juices, vegetable juice preparations, beer and malt beverages, spirituous beverages, wines, liquors, instant vegetable drinks, powdered soft drinks, instant coffees and teas, black teas, green teas, oolong teas, herbal infusions, cacaos, tea-based drinks, coffee-based drinks, cacao-based drinks, infusions, syrups, frozen fruits, frozen fruit juices, water-based ices, fruit ices, sorbets, breakfast cereals, cereal bars, energy bars/nutritional bars, granolas, pre-cooked ready-made rice products, rice flour products, millet and sorghum products, raw or pre-cooked noodles and pasta products.

14. A method of preparing a flavored food or beverage article, the method comprising the steps of:
(a) providing a food carrier or base or beverage carrier or base, and
(b) adding to the food carrier or base or beverage carrier or base, respectively, the flavor composition obtainable by the method as defined in claim 1.

15. A method of using the flavor composition obtainable by the method as defined in claim 1, the method comprising using the flavor composition for preparing a flavored food or beverage article.

16. The method according to claim 1, wherein the flavor composition is in a form of a solution, or dispersion.

17. The method according to claim 1, wherein the flavor composition comprises ethanol in the amount from 40 to 90% by weight and water in an amount from 10 to 40% based on the total weight of the flavor composition.

18. The method according to claim 1, wherein the flavor composition is a side-stream product of a dealcoholization process.

19. The method according to claim 1, wherein the dehydration process is a pervaporation process.

20. The method according to claim 1, wherein the adsorption process is conducted using a membrane comprising an organic or inorganic material.
